(19) United States
(12) Patent Application Publication
(10) Pub. No.: US 2019/0058350 A1
(43) Pub. Date: Feb. 21, 2019

(54) POWER FEEDBACK SYSTEM FOR ELECTRIC VEHICLE

(71) Applicant: DAR YUN ENERGY SCIENCE TECHNOLOGY CO., LTD., Taoyuan City (TW)

(72) Inventor: Yung-Chi Lu, Taoyuan City (TW)

(21) Appl. No.: 16/104,140

(22) Filed: Aug. 17, 2018

(30) Foreign Application Priority Data
Aug. 18, 2017 (TW) 106128054

(51) Int. Cl. H02J 7/16; B60L 11/18

(52) U.S. Cl. CPC H02J 7/163; B60L 2210/30; B60L 11/1809

(57) ABSTRACT

The power feedback system for an electric vehicle includes a generator, a charging controller, a battery module, and a current limiting controller. A first wheel of the electric vehicle drives the generator to produce an AC power. The charging controller converts the AC power from the generator into a DC power and delivers the DC power to the battery module. The current limiting controller receives and outputs the DC power in the battery module to a driving motor of the electric vehicle at a preset amperage. The driving motor then drives a second wheel to turn. The first wheel has an axle rotational speed greater than that of the second wheel, and the generator produces a greater current than the preset current of the current limiting controller. As such, the power consumption to the battery module is significantly reduced, greatly enhancing the electric vehicle's travelable distance.

### BACKGROUND OF THE INVENTION

### (a) Technical Field of the Invention

The present invention is generally related to electric vehicles, and more particular to a power feedback system for electric vehicles.

### (b) Description of the Prior Art

As people's environment awareness rises, energy saving and carbon reduction have become a global focus. As such, electric vehicles are gaining popularity lately, as they are ideal for environmental protection by not relying on fossil fuel and not producing any exhaust.

Generally, an electric vehicle has a battery module supplying electrical power to a driving motor, and the driving motor turns electric energy into kinetic energy by driving wheels of the electrical vehicle to spin.

As described, a travelable distance of an electric vehicle is therefore limited by the capacity of the its battery module. Due to the existing technology, the travelable distance of an electric vehicle is significantly inferior to that of a conventional vehicle.

### SUMMARY OF THE INVENTION

An objective of the present invention is therefore to provide a power feedback system for an electric vehicle that may increase the travelable distance of an electric vehicle by reducing power consumption to its battery module without employing a complex power conversion system.

The power feedback system includes a generator, a charging controller, a battery module, and a current limiting controller. The generator is coupled to a first wheel of the electric vehicle, and the first wheel drives the generator to produce an AC power. The charging controller and the generator are electrically connected together so as to convert the AC power from the generator into a DC power. The battery module is electrically connected to the charging controller for storing the DC power output from the charging controller. The current limiting controller is electrically connected to the battery module and the driving motor so that the DC power in the battery module is output to a driving motor of the electric vehicle at a preset amperage. The driving motor then drives a second wheel of the electric vehicle to turn. The first wheel has an axle rotational speed greater than that of the second wheel.

The gist of the present invention lies in that, when the electric vehicle is turned on, the driving motor drives the second wheel to turn, while the first wheel also turns to drive the generator to produce an AC power. The first wheel has an axle rotational speed greater than that of the second wheel. For example, if the second wheel's axle rotational speed is 1 RPM, the first wheel's axle rotational speed is greater than 1 RPM. Then, the first wheel drives the generator to produce a current greater than the preset constant current from the current limiting controller. As such, the power consumption to the battery module is significantly reduced or even almost no consumption at all, greatly enhancing the electric vehicle's travelable distance.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing a power feedback system according to an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

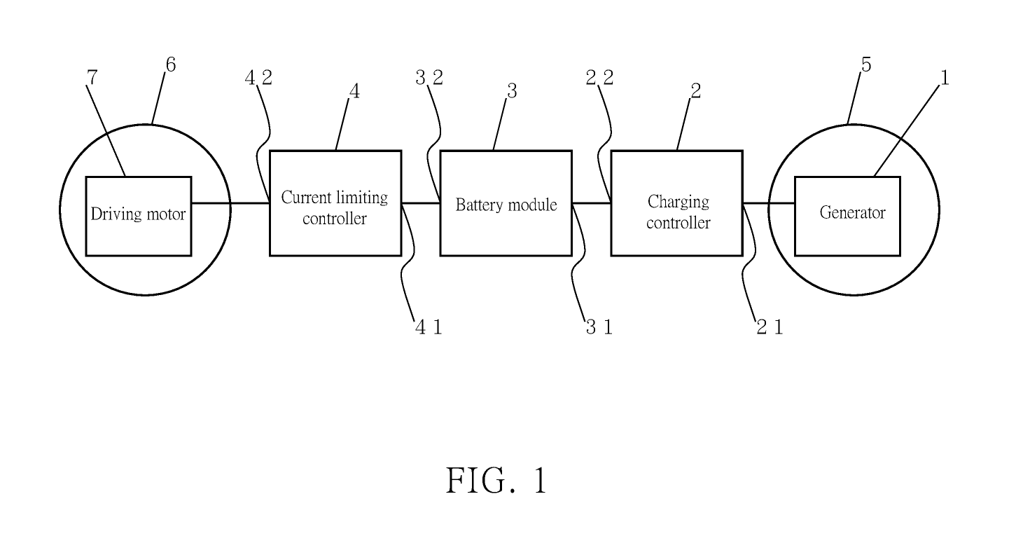

As shown in FIG. 1, the present invention teaches a power feedback system especially for an electric vehicle. The electric vehicle includes at least a first wheel 5 (e.g., a front wheel) and at least a second wheel 6 (e.g., a rear wheel), and the first wheel 5 has an axle rotational speed greater than that of the second wheel 6. The electric vehicle also includes at least a driving motor 7. The driving motor 7 is coupled to the second wheel 6 and the driving motor 7 drives the second wheel 6 to spin. The driving motor 7 may be a hub motor. The electric vehicle may be an electric bike, an electric motorcycle, or an electric automobile.

The power feedback system further includes a generator 1, a charging controller 2, a battery module 3, and a current limiting controller 4.

The generator 1 is coupled to the first wheel 5, and the first wheel 5 drives the generator 1 to produce an AC power.

The charging controller 2 and the generator 1 are electrically connected together so as to convert the AC power from the generator 1 into a DC power. The charging controller 2 has a first input terminal 21 and a first output terminal 22. The first input terminal 21 is electrically connected to the generator 1 so that the AC power from the generator 1 is delivered to the charging controller 2, and converted by the charging controller 2 into a regulated DC power. The charging controller 2 may be a two-way bridge rectifier.

The battery module 3 is electrically connected to the charging controller 2 for storing the DC power output from the charging controller 2. The battery module 3 has a second input terminal 31 and a second output terminal 32. The second input terminal 31 is electrically connected to the charging controller 2.

The current limiting controller 4 is electrically connected to the battery module 3 and the driving motor 7 so that the DC power in the battery module 3 is output to the driving motor 7 at a preset amperage. The current limiting controller 4 has a third input terminal 41 and a third output terminal 42. The third input terminal 41 is electrically connected to the battery module 3's second output terminal 32, and the third output terminal 42 is electrically connected to the driving motor 7.

Using an electric bike as an example, the present invention operates as follows. The first wheel 5 is the front wheel and the second wheel 6 is the rear wheel of the electric bike. When the electric bike is turned on, the driving motor 7 drives the second wheel 6 to turn. In the meantime, the first wheel 5 also turns and the first wheel 5 drives the generator 1 to produce an AC power. The generator 1 outputs the AC power to the charging controller 2 and the AC power is converted into a DC power. The charging controller 2 outputs the DC power to the battery module 3, and the battery module 3 delivers the DC power to the current limiting controller 4. Finally, the current limiting controller 4 output the DC power at a preset amperage to the driving motor 7. For example, if the driving motor 7 has a driving current at 10 amperes (A), the current limiting controller 4 outputs the DC power at a constant current 10 amperes (A) to the driving motor 7.

The gist of the present invention lies in that the first wheel 5 has an axle rotational speed greater than that of the second wheel 6. For example, if the second wheel 6's axle rotational speed is 1 RPM, the first wheel 5's axle rotational speed is greater than 1 RPM. Then, the first wheel 5 drives the generator 1 to produce a current greater than the preset constant current from the current limiting controller 4. In other words, the generator 1 produces a greater current than what is consumed by the driving motor 7. As such, the power consumption to the battery module 3 is significantly reduced or even almost no consumption at all, greatly enhancing the electric vehicle's travelable distance.

In an alternative embodiment, the charging controller 2 outputs an AC power and the battery module 3 is chargeable by an AC power. When the electric vehicle is turned on, the driving motor 7 drives the second wheel 6 to turn. In the meantime, the first wheel 5 also turns and the first wheel 5 drives the generator 1 to produce an AC power. The generator 1 outputs the AC power to the charging controller 2. The charging controller 2 outputs an AC power to the battery module 3, and the battery module 3 delivers a DC power to the current limiting controller 4. Finally, the current limiting controller 4 output the DC power at a preset amperage to the driving motor 7. For example, if the driving motor 7 has a driving current at 10 amperes (A), the current limiting controller 4 outputs the DC power at a constant current 10 amperes (A) to the driving motor 7.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A power feedback system for an electric vehicle, where the electric vehicle has at least a driving motor, at least a first wheel, and at least a second wheel, the first wheel has an axle rotational speed greater than that of the second wheel, and the driving motor is coupled to the second wheel and drives the second wheel to spin, the power feedback system comprising:
at least a generator coupled to and driven by the first wheel to produce an AC power;
a charging controller electrically connected to the generator and converting the AC power from the generator into a DC power, where the charging controller has a first input terminal and a first output terminal, and the first input terminal is electrically connected to the generator;
a battery module electrically connected to the charging controller for storing the DC power output from the charging controller, where the battery module has a second input terminal and a second output terminal, and the second input terminal is electrically connected to the first output terminal of the charging controller; and
a current limiting controller electrically connected to the battery module and the driving motor, where the DC power in the battery module is output to the driving motor at a pre-set amperage, the current limiting controller has a third input terminal and a third output terminal, the third input terminal is electrically connected to the battery module's second output terminal, and the third output terminal is electrically connected to the driving motor;
wherein, when the electric vehicle is turned on, the driving motor drives the second wheel to spin; as the first wheel turns, the generator is driven to produce the AC power; and, as the first wheel's axle rotational speed is greater than that of the second wheel, the generator produces a current greater than the preset amperage from the current limiting controller.

2. The power feedback system according to claim 1, wherein the driving motor is a hub motor.

3. The power feedback system according to claim 1, wherein the charging controller is a two-way bridge rectifier.

4. A power feedback system for an electric vehicle, where the electric vehicle has at least a driving motor, at least a first wheel, and at least a second wheel, the first wheel has an axle rotational speed greater than that of the second wheel, and the driving motor is coupled to the second wheel and drives the second wheel to spin, the power feedback system comprising:
at least a generator coupled to and driven by the first wheel to produce an AC power;
a charging controller electrically connected to the generator and converting the AC power from the generator into a second AC power, where the charging controller has a first input terminal and a first output terminal, and the first input terminal is electrically connected to the generator;
a battery module electrically connected to the charging controller for storing the second AC power output from the charging controller, where the battery module has a second input terminal and a second output terminal, and the second input terminal is electrically connected to the first output terminal of the charging controller; and
a current limiting controller electrically connected to the battery module and the driving motor, where a DC power output from the battery module is delivered to the driving motor at a pre-set amperage by the current limiting controller, the current limiting controller has a third input terminal and a third output terminal, the third input terminal is electrically connected to the battery module's second output terminal, and the third output terminal is electrically connected to the driving motor;
wherein, when the electric vehicle is turned on, the driving motor drives the second wheel to spin; as the first wheel turns, the generator is driven to produce the AC power; and, as the first wheel's axle rotational speed is greater than that of the second wheel, the generator produces a current greater than the preset amperage from the current limiting controller.
